(19) United States
(12) Patent Application Publication
(10) Pub. No.: US 2020/0220363 A1
(43) Pub. Date: Jul. 9, 2020

(54) METHOD AND DEVICE FOR CONTROLLING RECHARGING AND DISCHARGING OF BATTERIES OF A SET OF BATTERIES WITH PARTIAL RECHARGING OF A BATTERY

(71) Applicant: Orange, Paris (FR)

(72) Inventors: Didier Marquet, Châtillon Cedex (FR); Brian Francoise, Châtillon Cedex (FR)

(21) Appl. No.: 16/723,962

(22) Filed: Dec. 20, 2019

(30) Foreign Application Priority Data
Dec. 20, 2018 (FR) 1873552

(51) Int. Cl. H02J 7/00

(52) U.S. Cl. CPC H02J 7/0013; H02J 7/007

(57) ABSTRACT

Methods and devices are described for controlling recharging and discharging of batteries of a set of batteries, each of the batteries being connected to an electrical circuit connecting a main power supply source to a consuming device and a controllable electrical main discharging circuit connecting the battery to the consuming device and performing a diode function to prevent a circulation current between the batteries, the main power supply source being able to produce electrical energy intermittently, at least one first battery of the set of batteries being connected to a secondary power supply source by a controllable electrical saturation recharging circuit, the method comprising a partial recharging of the first battery by the main power supply source until a determined state of charge less than a maximum state of charge of the first battery, and a saturation recharging of the first battery by the secondary source until the maximum state of charge.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

### Technical Field

The disclosed technology relates to the general field of batteries of rechargeable electric storage cells. It relates more particularly to electric power supply to electronic devices situated in zones with no reliable electrical network, in other words, with no electrical network which satisfies strict requirements of electrical current, voltage and/or supplied power availability and stability.

### Description of the Related Art

To supply consuming electronic devices in zones not covered by electrical networks, a first solution consists of using generator sets, for example Diesel engines producing electrical power.

However, the generator sets are generally oversized relative to the operating power of the consuming devices that they supply, which leads to fairly low efficiency and to premature wear of the generator set. By way of an example, the operating powers required to supply a telecommunication device and an air conditioner are each of the order of 1 to 4 kW. In this case, the average charging rate of a generator set which supplies these two devices is only comprised between 10 and 50%.

A second solution consists of associating a battery with a generator set to form a hybrid power supply system (HGB for “Hybrid Genset Battery”). Two phases are alternated: for a first phase, the generator set supplies the consuming devices and also recharges the battery, then during a second phase, the generator set is stopped and the battery is discharged to supply the consuming devices. The first and the second phase can each last a few hours. This solution allows increasing the lifetime of the generator set by reducing its operating time, the cost of its maintenance, and by making it operate at a higher charging rate (because it is supplying the battery in addition to the consuming devices), ideally at 75% to obtain a lower fuel consumption.

In the case of the availability of an unreliable electrical network, for example with availability reduced to a few hours per day, a third solution for supplying consuming electronic devices consists of associating a battery with the unreliable electrical network: the battery is recharged and is kept charged as long as the electrical network is available, while the consuming devices are simultaneously supplied by this electrical network, and when the electrical network is no longer available, the battery is discharged to feed the consuming devices with an autonomy of several hours. This solution allows ensuring a continuous power supply of the consuming devices. Nevertheless, since it is not possible to control the activity state of the unreliable electrical network, it is not possible to guarantee that a battery is recharged fairly regularly to full saturation when the network is inactive. However, for lead-acid technology batteries, this saturation charge is a builder requirement to guarantee a specified lifetime. For batteries that can operate in partial state of charge, the requirement is less strict because it is only necessary to have enough energy to balance the charge of the elements.

The second and the third solution, both based on the use of a battery in alternation with another power supply source, have disadvantages linked to the lifetime of the batteries, to their costs and/or to constraints on using these batteries.

As regards currently available batteries and their use:

The most widely used batteries are of the lead-acid type. Their lifetime in charge and discharge cycles is limited, in particular with a high ambient temperature such as a temperature higher than 30° C. In Africa for example, the lifetime of a rechargeable lead battery performing up to ten charge/discharge cycles per week to 50% of its capacity is often only 2 to 4 years. However, a lead battery can include several branches connected in parallel at different charging states, which allows a defective branch to be replaced by another without risking cutting off the system.

Lead-acid batteries have another disadvantage: the time allowing to finish recharging from a high state of charge, of 95% for example, to a maximum state of charge, is relatively long. FIG. 1 of the prior art illustrates, as an example, evolutions of the state of charge, and of the current intensity required for recharging a lead-acid battery having a depth of discharge DoD of 80%. Note that Lead-acid batteries can be overcharged, i.e. recharged to a state of charge greater than 100%. In the example of FIG. 1, recharging from the state of charge of 95% to 105% lasts 5 hours and a half, while recharging it from the level of 0% to the level of 95% lasted 6 hours and a half. Also, the power required to recharge a Lead-acid battery decreases as the battery recharges. As a result, when a Lead-acid battery is associated with a generator set, this set operates at a low charging rate during the entire phase of finishing the recharging of the battery, from the high state of charge (95% in this example) to the maximum state of charge (105% in this example).

Advanced Lead-acid batteries allow a recharging faster than simple Lead-acid batteries, by accepting a stronger recharging rate due to the use of thinner plates. Compared to the conventional Lead-acid batteries, the advanced lead-acid batteries allow a larger number of cycles. The advanced Lead-acid batteries also allow partial recharges PSoC (for Partial State of Charge): several consecutive partial cycles with recharges to high states of charge but less than the maximum state of charge are possible, for example partial recharges up to 90 to 95%. However, full recharges (until 102 to 105% for example) are required after a certain number of partial cycles. The full recharging frequency depends on the depth of discharge applied to the battery, for example every 30 cycles for a battery having a DoD of 30%, and every 10 cycles for a battery having a DoD of 50%. The deeper the DoD is, the more often the battery needs to be fully recharged. In a hybrid power supply system HGB, the use of an advanced Lead-acid battery allows a reduction in the use of the generator set due to the partial cycles. However, the advanced Lead-acid battery is more sought (compared to a simple Lead-acid battery) because the operating time of the generator set is reduced. Also, the advanced Lead-acid batteries need to be recharged at least to the state of charge of 90% at each cycle.

Builder information and tests on lithium batteries show that their lifetime can reach from 6 to 7 years in deep cycle operation, i.e. with charge and discharge cycles in which discharge continues until the battery reaches its low voltage cutoff, generally defined as 70 to 90% discharge. However, lithium batteries have an initial cost 3 to 4 times greater than lead batteries and are therefore still little used (a few percent of the market). Moreover, paralleling lithium batteries is rather complex if these batteries are not at the same state of charge, i.e. at the same voltage.

The lithium batteries do not authorize overcharging because of a risk of thermal runaway. The lithium batteries allow partial recharges PSoC. A lithium battery having a DoD of 30% for example allows partial recharges to states of charge of the order of 40% to 70%. However, some Lithium batteries also require a full recharge after a certain number of partial recharges.

So-called high-temperature batteries such as liquid sodium batteries or nickel chloride batteries have good electrochemical efficiency, but their overall efficiency, with temperature held at approximately 300° C., is on the order of 50 to 75%. In addition, in the event of failure of the other power supply source (the generator set or the unreliable electrical network), the intervention period must not exceed the cooling time of the high-temperature battery, because a cooled battery can require up to several days to increase temperature slowly so as not to break the internal ceramics of the battery. Thus high-temperature batteries are used only with other reliable power supply sources and in zones that are rapidly accessible for maintenance.

REDOX or “flow” batteries such as vanadium salt oxidation-reduction flow batteries have the advantage of being able to increase capacity by increasing the size of an external liquid reservoir. But these batteries have embodiments efficiency in constant use due to electrical leakage between the series elements via the conducting saline fluids used and they demand a good deal of maintenance. For example, the zinc-bromine REDOX battery must be stopped once per week for its regeneration and its automatic internal cleaning. In addition, operation in alternation of REDOX batteries with another power supply source has not been proposed.

For this reason, even the second and third previously described solutions, which use a battery in an HGB system, are not satisfactory.

There exists a need for a solution allowing supplying consuming electronic devices in a zone not having a reliable electrical network, and which does not have some of the disadvantages of the prior art.

### SUMMARY

The disclosed technology includes a method for controlling recharging and discharging of batteries of a set of said batteries, each of these batteries being connected to an electrical circuit connecting a power supply source, called main source, to a consuming device to form:
a controllable electrical circuit, called “partial recharging circuit”, connecting the battery to the power supply source; and
a controllable electrical circuit, called “main discharging circuit”, connecting the battery to the consuming device and performing a diode function to prevent a circulation current between the batteries,
the main source being able to produce electrical energy intermittently;
at least one first battery of the set being connected to another power supply source, called secondary source, by a controllable electrical circuit called “saturation recharging circuit”;
said method comprises:
a partial recharging of the first battery by said main source until a determined state of charge less than a maximum state of charge of said first battery, said partial recharging comprising a closing of said electrical partial recharging circuit of said first battery; and
a saturation recharging of said first battery (B1) by said secondary source (SOL, WND, B2) until said maximum state of charge, said saturation recharging comprising a closing of said electrical saturation recharging circuit and an opening of said electrical partial recharging and main discharging circuits of said first battery,
said method being such that the consuming device is supplied by the main source, and/or by the secondary source, and/or by a main discharging of one said battery;
said main discharging of one said battery comprising an opening of the electrical partial recharging circuit and a closing of the electrical main discharging circuit of this battery.

As a corollary, the disclosed technology also includes a control device for controlling recharging and discharging of batteries of a set of said batteries, each of these batteries being intended to be connected to an electrical circuit connecting a power supply source, called main source, to a consuming device to form a controllable electrical circuit, called partial recharging circuit, connecting the battery to the main power supply source, and a controllable electrical circuit, called main discharging circuit, connecting the battery to the consuming device and performing a diode function to prevent a circulation current between the batteries,
the main source being able to produce electrical energy intermittently;
at least one first battery of the set being intended to be connected to another power supply source, called secondary source, by a controllable electrical circuit called “saturation recharging circuit”, the control device includes a coupling module configured to control:
a partial recharging of the first battery by the main source until a determined state of charge less than a maximum state of charge of the first battery, said partial recharging comprising a closing of the electrical partial recharging circuit of the first battery;
a saturation recharging of the first battery by said secondary source until said maximum state of charge, the saturation recharging comprising a closing of the electrical saturation recharging circuit and an opening of said electrical partial recharging and main discharging circuits of the first battery; and
a main discharging of one said battery comprising an opening of the electrical partial recharging circuit and a closing of the electrical main discharging circuit of this battery,
the control device being configured to supply the consuming device by the main source, and/or by the secondary source, and/or by a main discharging of one said battery.

Thus, the consuming device is supplied without cutoff, in other words continuously, by the main power supply source, and/or by the secondary power supply source, and/or by the discharging of a battery.

The consuming device is distinct from the main power supply source and from the secondary power supply source.

The features and advantages of the control method presented hereafter apply in the same manner to the control device, and vice versa.

The main source can produce electrical energy from a non-renewable energy such as fossil energy like oil, gas and coal, or a nuclear energy. In one embodiment, the main source is a generator set forming, with the set of batteries, a hybrid power supply system HGB.

The partial recharging of a battery is a phase during which the battery is supplied electrically by the main power supply source and stores electrical energy. During this phase, the state of charge of the battery increases.

The main discharging of a battery is a phase during which the battery provides electrical energy, to supply the consuming device. During this phase, the state of charge of the battery decreases.

The nominal values of capacity and of voltage of a battery are those defined by the builder of the battery in compliance with a standard.

The diode function associated with a battery allows preventing a circulation current between this first battery and a second battery. Recall that such an inter-battery circulation current can occur when the batteries are not at the same state of charge, and when the recharging circuit or the discharging circuit of a first battery is closed simultaneously with the closing of the discharging circuit of a second battery. It can be noted that this inter-battery circulation current can be much higher than the discharging current of the batteries, and can therefore destroy them.

For example, we consider a thin plate pure lead storage cell of 100 Ah (Ampere-hour) charged at 2.1 V of electromotive force, and having an internal resistance of 5 mOhms. When this storage cell discharges more than half of its discharging capacity for a rate of 3 hours (3 h) by providing a current of the order of 33 Amperes (A), it will have after discharging a voltage of 1.9V, and its internal resistance will have increased by a few mOhms, for example by 8 mOhms. Consider two 48V nominal batteries each comprising 24 previous storage cells in series. If these two batteries are connected in parallel, the inter-battery circulation current could reach 24×VoltageDifference/InternalResistance=24*(2.1-1.9 V)/(5+8 mOhms), namely 369 Amperes. Such an inter-battery current would be 10 times higher than the discharging and charging current (33A) observed at 3 h rate. This example represents a case of common use for the HGB-type hybrid systems.

Due to the diode function, the disclosed technology allows preventing such a circulation current between the batteries. Thus, it protects the batteries and extends their lifetime.

One cycle of a battery includes at least one partial recharging and at least one main discharging of this battery.

At least the first battery accepts the partial recharges; such a battery can be for example an advanced lead-acid battery or a lithium battery.

The disclosed technology allows avoiding the activation the main source for a long duration and at a low charging rate, to recharge a battery from the determined state of charge that can be reached by the partial recharging, until to the maximum state of charge of the battery.

Thus, the disclosed technology allows reducing the Total Cost of Ownership TCO and the OPerational EXpenditure OPEX of the main source, due to the decrease in the time of use of this source and thus the decrease in the frequency of its maintenance.

The disclosed technology also allows reducing the consumption of the non-renewable energy (oil, gas, coal) from which the main source produces electrical energy. The disclosed technology therefore allows reducing the pollution and the emission of CO2 by the main source.

Each battery of the set can be connected to one or more power supply source(s) and to one or more consuming device(s).

A battery can include a single branch or more branches having the same voltage, operating in parallel and made of blocks. For example, a battery can include two parallel branches of 48V, each branch including four blocks of 12V each.

In one embodiment, the control method further includes a step of counting, for each battery of the set, a number of cycles performed for this battery which each comprise a partial recharge. The saturation recharging of the battery is implemented after a determined number of cycles.

In one embodiment, the partial recharge of the first battery further includes an opening of the electrical main discharging circuit of this battery. In another embodiment, when the electrical main discharging circuit of the first battery is closed, this main discharging circuit will be short-circuited during a partial recharging of the first battery.

In one embodiment, the control method further includes a discharging called secondary discharging of the first battery for a saturation recharging of a second battery of the set. The first battery constitutes a secondary source for the second battery. The secondary discharging of the first battery comprises an opening of the partial recharging circuit of this first battery. The electrical saturation recharging circuit of the second battery constitutes an electrical “secondary discharging” circuit for the first battery.

This embodiment allows using a battery of the set for saturation recharging of another battery.

In one embodiment, the first battery in secondary discharge, is also in main discharge. Therefore, this embodiment allows using the first battery simultaneously for saturation recharging of the second battery, and also for supplying the consuming device.

The electrical partial recharging, saturation recharging, main discharging and secondary discharging circuits of a battery can be controlled independently of each other. The independence of the charging and discharging circuits allows introducing a redundancy.

In another embodiment, the secondary source is a source that can produce electricity from a renewable energy, like solar, wind, hydraulic or geothermal energy.

In one embodiment, the saturation recharging of a battery can be performed simultaneously by a secondary discharging of another battery and by a secondary source producing electricity from a renewable energy.

In one embodiment, the control method comprises:
a first sequence including a saturation recharging, at least one partial recharging, and at least one main discharging, for the first battery;
a second sequence including a saturation recharging, at least one partial recharging, and at least one main discharging, for another battery of the set, called third battery;
both sequences being temporally adjusted to ensure continuous power supply via the main discharging circuits of the first and third batteries.

Each of the two sequences includes, on the one hand, one or more partial recharge and main discharge cycle(s), and on the other hand, a saturation recharge. Thus, this embodiment allows each of the two batteries to be recharged until its maximum state of charge after a certain number of partial recharge cycles.

Also, this embodiment allows ensuring the continuous power supply of the consuming device by the main discharging of the first or the third battery, or by the main source when the latter is active.

In one embodiment, the control method further comprises, for at least one battery of the set, a cyclic sequence including:
at least one said partial or saturation recharging followed by resting; and/or
at least one said main or secondary discharging followed by resting,
said resting including an opening of said electrical circuits of said battery.

Resting a battery is its disconnection from any power supply source and from any consuming device. During this phase, a state of charge of the battery remains constant.

This embodiment allows in particular extending the lifetime of the batteries due to the rest time separating the recharge and discharge phases and/or vice versa. In fact, the batteries of the set are recharged and discharged alternately.

Experimental tests have been able to demonstrate a reduction in ageing in terms of loss of capacity per cycle due to resting between recharge and discharge phases of lithium storage batteries, even when making them operate at 100% of the nominal capacity.

For example, at a temperatures between 35 and 45° C. and over 1000 recharge and discharge cycles, the resting of a battery for 15 to 30 minutes between the recharging and discharging phases and vice versa allows the ageing slope to be reduced from ten percentage points to a few percentage points. Under these conditions, the lifetime of the battery can reach more than ten years. The use of lithium batteries can then be favored relative to lead batteries, given that over such a long lifetime, there will be a return on the initial investment.

The resting of one battery can allow reducing the temperature of the battery, which improves its lifetime, but also reduces the need to operate equipment for cooling the battery, such as an air conditioning unit. The disclosed technology therefore allows reducing energy consumption.

In one embodiment, at least one sequence among said first and said second sequence, further includes a resting of the corresponding battery. Resting of the batteries is introduced without reducing the power supply of the consuming device.

The batteries in the set can have different nominal capacities or the same nominal capacity.

In one embodiment, at least one battery in said set is of the lithium type. As mentioned previously, the lithium battery offers deep cycles, works between 80 and 100% of nominal capacity, and has a longer lifetime than other types of batteries. In addition, the extension of the lifetime of the lithium battery due to its resting allows having a return of investment on the initial cost of the lithium battery.

In one embodiment, at least one battery of said set is of the lithium or nickel type (for example NiCd, NiZn or NiMH) accepting sufficient power during recharging and discharging so that a single battery of said set can, on the one hand, supply all the power required by the consuming device and, on the other hand, accept the maximum power of the power supply source.

The capacity of the set of batteries can be equal to the capacity of a single battery in conformity with a power supply solution of the prior art. The fact of having a set of at least two batteries does not result in an increase of the cost of batteries relative to the solutions of the prior art.

In one embodiment, the resting is not added systematically after each recharging and after each discharging. It is possible to rest a battery after each recharge of this battery for example, or after each discharge, or after a given number of cycles. The gain in terms of lifetime of a battery decreases as this number of cycles increases.

In one embodiment, the control method also comprises, alternately between at least two batteries of the set, a sequence including:
at least one partial or saturation recharging followed by resting; and
at least one main or secondary discharging followed by resting;
the durations of recharging, discharging and resting of this sequence being able to be different for each of the batteries.

The disclosed technology therefore allows supplying the consuming device while lengthening the lifetime of each of the alternated batteries.

In one embodiment, the saturation recharging of a battery is not performed by the main power supply source. Therefore, this embodiment allows reducing the energy consumption, particularly fuel consumption when the main power supply source is a generator set.

In one embodiment, the control method further comprises a step of inspecting information representing an activity state of the main source. As long as the state of the power supply source is active, the partial recharging of the first battery is implemented until the determined state of charge, the consuming device being supplied by the main power supply source. As long as the state of the main power supply source is inactive, the consuming device is supplied by the secondary source and/or by the main discharging of a battery.

In one embodiment, the control method also comprises a step consisting of monitoring information representing an activity state of the main source.

In one embodiment, the control method further comprises a step of verifying the availability of the secondary source.

In one embodiment, the control device further comprises a verification module configured to monitor information representing an activity state of the main source and/or to verify an availability of the secondary source.

In one embodiment, the control method further includes a step of obtaining at least one piece of information representing a state of charge of a battery of the set for determining the battery that is in saturation recharge, or partial recharge or main discharge or secondary discharge.

The determination of the battery to which a recharge or discharge is applied is then based on precise information on the state of charge of each battery, which reduces the risks of selecting for the discharge, a battery which is not sufficiently charged to be able to supply the consuming device and/or to recharge in saturation another battery, or selecting for recharge, a battery already having a high state of charge when another battery exists with a greater need of recharging.

The information representing a state of charge of a battery can be obtained for example by physical measurements, or by estimates such as calculations performed by machine learning algorithms.

The information representing a state of charge of a lithium battery can be obtained by the control device by receiving this information from a BMS entity (for “Battery Management System”) associated with this battery.

In another embodiment, determining a battery to which recharging or a discharging is applied is accomplished systematically in alternation between the different batteries of the set, based on a chronometer for example, or on a period of availability of the power supply source.

In one embodiment, a duration of activity and a duration of inactivity of the main power supply source are determined in advance; in other words, these durations are predefined. For example, the durations of activity and of inactivity can be predetermined to have constant values. The main source can be activated or deactivated alternately and according to the durations of activity and inactivity. This embodiment therefore allows simple and periodic control.

In another embodiment, the duration of activity and the duration of inactivity of the power supply source are determined depending on the information representing the state of charge of a battery.

This embodiment allows optimizing gains in terms of the lifetimes of the batteries and of the main power supply source because it is based on information regarding states of charge of the batteries. This embodiment also allows guaranteeing the availability of power supply for the consuming device.

In one embodiment, the control device also includes a monitoring module configured to obtain an information representing a state of charge of a battery, to determine a battery to be recharged or discharged.

In one embodiment, the control device also includes a control module configured to control the activity state of the main power supply source.

In one embodiment, the electrical circuits of partial recharging, saturation recharging, main discharging and secondary discharging corresponding to a battery of the set are included in the control device, or in the same physical housing as the control device. In another embodiment, these electrical circuits are not part of the control device, but are controlled by the coupling module of the control device.

The disclosed technology also includes a control system for controlling recharging and discharging batteries of a set of said batteries, each of these batteries being connected to an electrical circuit connecting a main power supply source to a consuming device to form a controllable electrical circuit, called partial recharging circuit, connecting the battery to the power supply source and by a controllable electrical circuit, called main discharging circuit, connecting the battery to the consuming device and performing a diode function to prevent a circulation current between the batteries, the main source being able to produce an electrical energy intermittently, at least one first battery of the set being connected to another power supply source, called secondary source, by a controllable electrical circuit called “saturation recharging circuit”, the system including:
a control device, as previously described;
the main power supply source;
the secondary source; and
the consuming device.

In operation, the control device is such that the consuming device is supplied either by the main source, the secondary source and/or by the discharging of a battery.

In one embodiment, the main power supply source is an electrical generator or a generator set.

In one embodiment, the secondary source is a source that can produce electrical energy from a renewable energy, like a solar panel or a wind turbine, or a battery of the set, in secondary discharge. Several types of secondary sources can then be considered.

In one embodiment, the consuming device is a wireless communication base station or a medical device.

The disclosed technology can therefore be implemented for supplying telecommunications equipment and therefore ensuring coverage of a communications network in zones which do not have a reliable electrical network available, such as rural zones or zones with difficult geographic, climatic or economic conditions.

The disclosed technology can also be implemented for supplying, in such zones, medical devices having requirements in terms of availability of power supply, necessitating for example permanent availability.

The disclosed technology can also be implemented for feeding, in such zones, other devices with less demanding constraints.

The disclosed technology also applies to a computer program on a storage medium, this program being capable of being implemented on a computer or in a control device, this program including suitable instructions for implementing a control method as described above.

This program can use any programming language and be in the form of a machine code, source code, object code or intermediate code between the source code and the object code, such as in a partially compiled form, or in any other desirable form.

In particular, this program can be executed by a microcontroller μC.

The disclosed technology also includes information or storage media readable by a computer, and including instructions of the computer program as mentioned above.

The information or storage media can be any entity or device capable of storing programs. For example, the media can include a storage means, such as a ROM, for example a CD ROM or a ROM of a microelectronic circuit, or even a magnetic storage means, such as a diskette (floppy disk) or a hard disk, or a flash memory.

On the other hand, the information or storage media can be transmissible media such as an electrical or optical signal, which can be routed via an electrical or optical cable, by radio link, by wireless optical link or by other means.

The program can in particular be uploaded on a network of the Internet type.

Alternatively, each information or storage medium can be an integrated circuit into which the program is incorporated, the circuit being adapted to execute or to be used in the execution of the control method.

### BRIEF DESCRIPTION OF THE DRAWINGS

Other features and advantages of the disclosed technology will be revealed from the description given below, with reference to the appended drawings which illustrate an embodiment of it free of any limiting character. In the figures:

FIG. 1, already described, illustrates evolutions in the state of charge and current intensity required to recharge a lead-acid battery of the prior art;

FIG. 2 illustrates a control system of two batteries in conformity with one embodiment;

FIG. 3 is a flowchart showing the steps of a control method in conformity with the embodiment presented in FIG. 2;

FIG. 4 is a timetable showing the states of charge of batteries controlled according to the control method, the steps of which are presented in FIG. 3;

FIG. 5 illustrates functional architectures of a control system and device according to an embodiment allowing a saturation recharging of a battery by another battery;

FIG. 6 illustrates functional architectures of a control system and device according to another embodiment allowing a saturation recharging of a battery by another battery;

FIG. 7 illustrates functional architectures of a control system and device according to an embodiment allowing a saturation recharging of a battery by a secondary source different from a battery of the set;

FIG. 8 illustrates functional architectures of a control system and device according to another embodiment allowing a saturation recharging of a battery by a secondary source different from a battery of the set;

FIG. 9 illustrates functional architectures of a control system and device according to a hybrid embodiment between the embodiments of FIGS. 5 and 7;

FIG. 10 illustrates functional architectures of a control system and device according to a hybrid embodiment between the embodiments of FIGS. 6 and 8;

FIG. 11 is a timetable showing states of charge of batteries controlled by a control method in conformity with two embodiments; and

FIG. 12 illustrates the material architecture of a control device according to one embodiment.

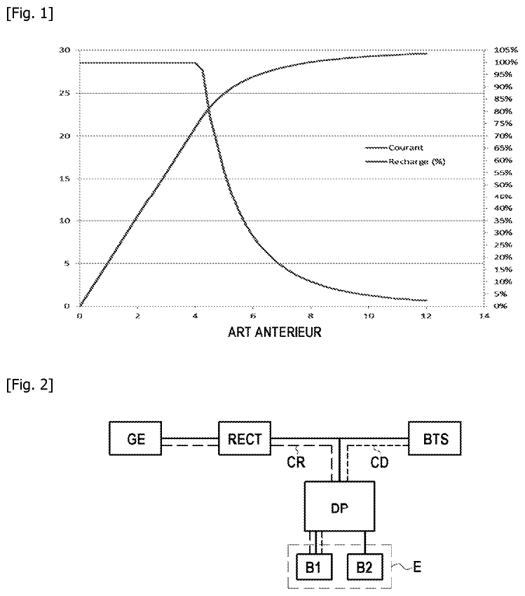

### DETAILED DESCRIPTION

FIG. 2 illustrates an architecture of a control system for a set E of batteries B1 and B2. Each of these batteries B1 and B2 is connected to an electrical circuit connecting a main power supply source GE to a consuming device BTS to form:
a controllable electrical partial recharging circuit CR connecting the battery to the power supply source GE; and
a controllable electrical main discharging circuit CD connecting the battery to the consuming device BTS.

The main source can produce electrical energy intermittently.

In the embodiment described here, each of the two batteries, B1 and B2, constitutes another power supply source, called secondary source, and it is connected to the other battery by a controllable electrical circuit called “saturation recharging circuit”.

The electrical saturation recharging circuit of the battery B1 constitutes an electrical “secondary discharging” circuit for the battery B2. In the same way, the electrical saturation recharging circuit of the battery B2 constitutes an electrical secondary discharging circuit for the battery B1.

The system includes:
a control device DP;
the main power supply source GE; and
the secondary source, including alternately, one of the batteries B1 or B2; and
the consuming device BTS.

In this embodiment, the main power supply source is a generator set forming with the batteries B1 and B2 a hybrid power supply system of the HGB type. The two batteries B1 and B2 are of the advanced Lithium or Lead-acid type, allowing partial recharges. The consuming device BTS is a base station of a telecommunications network.

The control system is situated in a rural zone not having an electrical network available. Permanent electrical power supply (without cutoff i.e. without interruption) of the consuming device BTS is required to ensure network coverage in this rural zone.

The control device DP implements a control method to control the recharging and the discharging of the batteries B1 and B2. The control device DP controls partial recharging of the batteries by the main source GE, to states of charge NRMIN strictly less than maximum states of charge NRMAX of these batteries, in order to prevent the activation of the main source GE at a low charging rate when slowly recharging a battery from a state NRMIN to a state NRMAX. In addition, the control device DP controls a secondary discharging of one of the batteries (B1 for example) for a saturation recharging of the other battery (B2) from the state of charge NRMIN to the state of charge NRMAX.

In this example, rectifiers RECT are placed at the output of the power source GE to convert an alternating current AC generated by the main source GE into direct current DC.

Hereafter we designate, by “controlling recharging or discharging of a battery,” controlling the electrical recharging and discharging circuits of this battery.

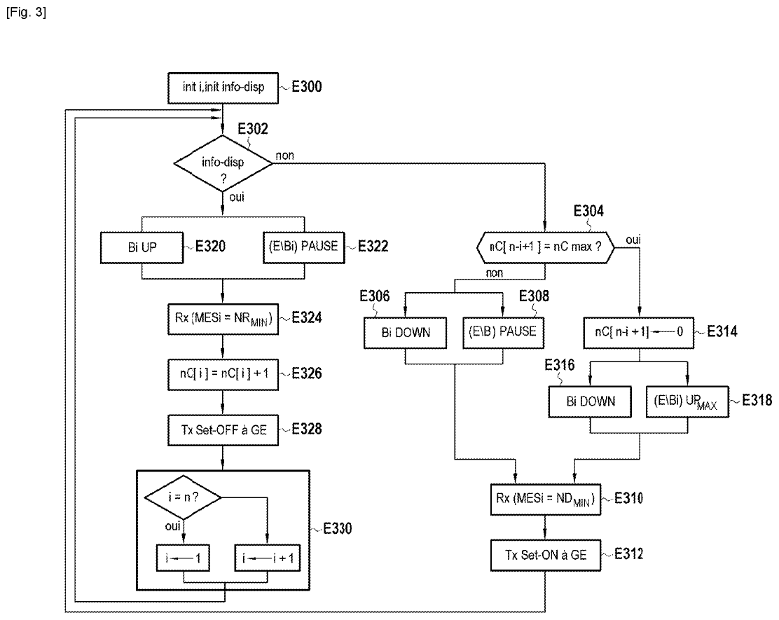

FIG. 3 is a flowchart representing the steps of a method for controlling a set E of two batteries B1 and B2 in conformity with an embodiment. The method is implemented by the control device DP and comprised in the control system described with reference to FIG. 2.

In this embodiment, the consuming device BTS is supplied either by the generator set GE, or by a main discharging of one of the batteries B1 or B2.

In this embodiment, the control device DP controls the batteries B1 and B2 of the set E, but also the activity state of the generator set GE.

The method is initiated during a step E300, considering for example that the last battery Bi having been rested is battery B1 and that the power supply source GE is initially in an inactive state. The index “i” is a positive integer comprised between 1 and the number of batteries of the set E, that is to say between 1 and 2 in this example, initialized during step E300 to the value 1. The activity state of the generator set GE is initialized during step E300 to be inactive.

It is assumed that initially, the batteries B1 and B2 are charged to a high state of charge NRMIN, but less than the state of full charge NRMAX of 100%. The level NRMIN is 90% in this example.

During a step E302, the control device DP obtains an information info-disp representing the activity state of the main power supply source GE, this information being provided by the control device itself. This information indicates that the source GE is in the inactive state.

In the embodiment described here, a counter nC[i] of number of cycles is associated with each battery Bi of the set, each cycle comprising a partial recharge and a main discharge. The control device DP uses these counters nC[i] to control, for each battery Bi, a saturation recharging after a determined number nCmax of cycles each including a partial recharge.

In this embodiment, when the state of the main source is inactive and the index i designates a particular battery for example B1, the control device verifies during a step E304 whether the counter nC[n−i+1] associated with the other battery of the set, B2 in this example, has reached the maximum number nCmax.

It is assumed that during step E304, the control device DP has verified that the counter nC[2] has not reached the value nCmax.

In order to supply the consuming device BTS, the device DP controls during a step E306 the electrical circuits of the battery B1 for its main discharging until a determined state of charge NDMIN, of 50% for example.

Simultaneously with the discharging E306, during a step E308, the device DP rests the battery B2, by controlling the opening of the circuits of the battery B2 to rest it.

During a step E310, the control device DP receives an information MES1 representing the state of charge of the battery B1, this information indicates that the state of charge of the battery B1 has reached the state of charge NDMIN of 50%.

In the embodiment described here, as soon as a battery is discharged until the level NDMIN, the control device DP controls its partial recharging by the main source GE until the state of charge NRMIN of 90%. In fact, the batteries B1 and B2 authorize partial recharging.

To maintain the power supply of the consuming device BTS, the device DP controls, during a step E312 the starting of the generator set GE. The consuming device BTS is then directly supplied by the main power supply source GE.

Following step 312 and during a new iteration of the step E302, the information info-disp then indicates that the power supply source GE is active. The value of the index i is still 1.

During a step E320, the device DP controls a partial recharging of the battery B1 until a state of charge NRMIN, and simultaneously, during a step E322, a resting of the battery B2.

Note that the generator set GE is supplying both the consuming device BTS and the battery B1.

During a step E324, the control device DP receives an information MES1 representing the state of charge of the battery B1, this information indicating that this battery B1 is charged to the level NRMIN.

After each recharge of a battery Bi until the level NRMIN, the control device DP increments, during a step E326, the counter nC[i] of number of cycles associated with the battery Bi. In this example, the counter nC[1] associated with the battery B1 is incremented.

Upon reception of the information MES1, the device DP controls during a step E328 the deactivation of the main source GE.

The steps E326 and E328 can be implemented simultaneously or one after the other regardless of which precedes the other.

During a step E330, the control device DP modifies the integer i for changing at each iteration, the battery relating to the main discharging step (E306) and then to the partial recharging step (E320). If the integer i is equal to the number of batteries n, then i is reinitialized to 1, otherwise i is incremented by one unit.

The method repeats starting with step E302. The state of the main source GE is inactive.

In this example, the new value of the integer i is 2. The control device verifies during the step E304 whether the counter nC[n−i+1] associated with the other battery of the set, B1 in this example, has reached the maximum number nCmax. It is assumed that this is the case (nC[1]=nCmax), the control device DP sets the counter nC[n−i+1] to zero during a step E314, and controls a secondary discharging of the battery identified by the index i (B2) during a step E316 until the state of charge NDMIN and a saturation recharging of the other battery (B1) during a step E318 simultaneous with step E316, until the state of charge NRMAX.

During the steps E316 and E318, the battery B1 is recharged by the battery B2 from its state of charge NRMIN until the level NRMAX. In fact, recall that before deactivating (E328) the main source GE, the control device DP has obtained (E324) the measurement MES1 indicating that the state of charge of the battery B1 is NRMIN.

Steps E316 and E318 are followed by step E310 previously described.

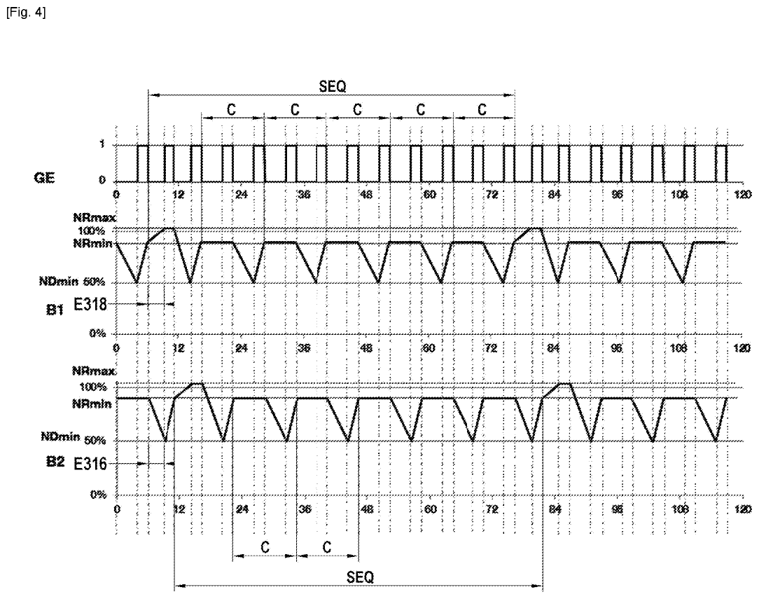

FIG. 4 is a timetable showing the different steps of the control method in conformity with the embodiment described with reference to FIG. 3. This timetable shows the evolution of the states of charge of the batteries B1 and B2 as a function of time, in hours.

Both batteries B1 and B2 have the same nominal voltage and the same nominal capacity. The sum of the capacities of the batteries B1 and B2 may approximately correspond to that of a conventional HGB system of the prior art. Recall that an HGB power supply system of the prior art includes a single battery or several batteries connected in parallel and operating in parallel both in recharge and in discharge.

The main discharging of the battery B1 (E306) and the resting of the battery B2 (E308) last, in FIG. 4, from the instant 0 until the fourth hour.

The activation step E312 of the source GE is implemented at the fourth hour.

The partial recharging of the battery B1 (E320) and the resting of the battery B2 (E322) last from the fourth hour until the sixth hour. At the sixth hour, the step E328 is implemented to deactivate the generator set.

The loop is repeated starting at the sixth hour with a new implementation of step E302 after modifying E330 the index i from the value 1 to the value 2.

The secondary discharging of the battery B2 (E316) simultaneous with the saturation recharging of the battery B1 (E318) is marked in FIG. 4. These steps E316 and E318 last from the sixth to the tenth hour. In this example, the number nCmax is equal to 6.

At the tenth hour, the state of the main source GE is activated (E312) for a partial recharging (E320) of the battery B2, simultaneous with a resting (E322) of the battery B1.

In this embodiment, a cyclic sequence C with a duration of 12 hours is applied to the battery B1, including a resting (which lasts 6 hours), a main discharging (which lasts 4 hours), then a partial recharging (which lasts 2 hours).

In this embodiment, a cyclic sequence C with a duration of 12 hours is applied to the battery B1, including a resting (which lasts 6 hours), a main discharging (which lasts 4 hours), and then a partial recharging (which lasts 2 hours).

In addition, the cyclic sequence C is alternately applied between the batteries B1 and B2. The application of this cyclic sequence to the battery B2 is offset by 6 hours relative to its application to the battery B1.

In this embodiment, another cyclic sequence SEQ is applied alternately between the batteries B1 and B2.

The sequence SEQ includes:
a saturation recharging, which lasts 4 hours, by a secondary discharging of the other battery of the set;
a resting that lasts 2 hours;
a secondary discharging, that lasts 4 hours, for a saturation recharging of the other battery of the set;
a partial recharging; and
five times the sequence C already described.

In this embodiment, since the batteries B1 and B2 have the same capacity, the durations of partial recharging, saturation recharging, main discharging, secondary discharging and resting are identical for the two batteries.

In this embodiment, the control device DP activates (E312) the source GE as soon as the state of charge of one of the batteries B1 or B2 is considered low (NDMIN). Alternatively, the control device DP can activate the source GE only when all the batteries B1 and B2 have the state of charge NDMIN.

In this embodiment, since each battery B1 and B2 has half the capacity of a battery of an HGB system of the prior art, the source GE is started twice as often, but its operating time is the same. According to data of generator set manufacturers, up to ten starts per day do not reduce the lifetime of a generator set GE and of its starter.

A person skilled in the art can initially configure the states of charge of the batteries B1 and B2 and the values of the counters nC[i] to implement the method illustrated by the flowchart of FIG. 3. For example, an initial configuration may consist in installing the battery B1 at the state of charge NRMAX and the battery B2 at the level NRMIN, deactivating the main source GE, and setting the value of the index i to 1, the counter nC[1] associated with the battery B1 to 0 and the counter nC[2] associated with the battery B2 to nCmax, such as the situation at the hour 12.

### Other Embodiments

The embodiment already described can have different variants, for example in the selection of the states of charge which trigger recharging or discharging of a battery.

In one embodiment, the control system includes several main power supply sources, of the same type or of different types.

In one embodiment, the control system includes at least two main power supply sources of which one is a Stirling type generator. This type of generator can cover the operating power, i.e. supply the consuming device BTS, but not the recharging of the batteries.

The main power supply source can remain active during a saturation recharging of a battery.

The consuming device can be a device other than a base station BTS or a medical device HOSP. The consuming device is an electronic device which requires being supplied with electrical power with a minimum threshold of availability and/or a minimum threshold of stability in the level of intensity of the current, the voltage or the electrical power supplied to it.

In one embodiment, the control system includes several consuming devices.

In one embodiment, at least one of the batteries B1 and B2 controlled by the control device is of the lead or nickel type, or a high-temperature battery.

The batteries B1 and B2 of the set E of batteries are not necessarily of the same technology.

In one embodiment, the data mes1, mes2, mes3 representing the states of charge of the batteries of the set E are based on measurements of current or of voltage at the batteries.

In one embodiment, the data mes1, mes2, mes3 representing the states of charge in the batteries of the set E are based on estimates, using for example machine learning algorithms.

In one embodiment, the data mes1, mes2, mes3 representing the states of charge of the batteries are based on countdown timer. For example, it can be estimated that battery B1, the state of charge of which is presented in FIG. 4, is discharged (main discharging) from the level NRMIN to the level NDMIN in 4 hours, and partially recharges from the level NDMIN to the level NRMIN in 2 hours.

In one embodiment, the control system further includes a secondary power supply source different from a battery of the set, for example a source producing electrical energy from a renewable energy, like a solar panel or a wind turbine. The secondary source can be used:
alone or with the main source for a partial recharging of a battery; and/or
alone or with a battery in secondary discharge for a saturation recharging of another battery.

Description of a Control Device

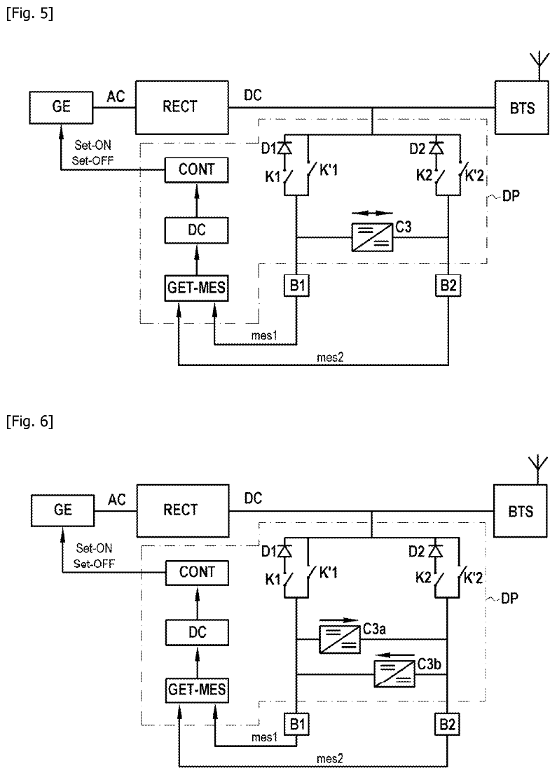

FIG. 5 shows a functional architecture, according to one embodiment, of a control system SYS including the control device DP, a main power supply source GE, a set of two batteries B1 and B2, and a consuming device BTS.

The control device DP controls the set of the two batteries B1 and B2 each of which can be connected to the main power supply source GE, and to the consuming device BTS.

The control device DP includes:
a coupling module DC;
connection means K1, K′1 (and K2, K′2) and a diode function D1 (and D2) forming the electrical partial recharging CR and main discharging CD circuits of the battery B1 (and of B2), connecting this battery to the source GE and to the consuming device BTS;
a bidirectional C3 converter connecting the battery B1 to the battery B2, and forming at each of the batteries an electrical saturation recharging circuit (when it is in saturation recharge by the other battery) or a secondary discharging circuit (when it is in secondary discharge to recharge the other battery);
a monitoring module GET-MES; and
a control module CONT.

The connection means K1, K′1 relating to the battery B1 are configured to ensure an electrical connection between the battery B1 and the main power supply source GE for partially recharging the battery (CR circuit), or ensure an electrical connection between the battery B1 and the consuming device BTS for a main discharging of the battery (CD circuit) to supply this consuming device BTS, or electrically disconnect the battery B1 from the power supply source and from the consuming device.

In fact, two parallel circuits relate to each battery. For the battery B1 for example, the circuit including the means K1 and D1 in series, called main discharging circuit CD, allows passage of an electrical current for discharging the battery B1, while the circuit including the means K′1, called partial recharging circuit CR, allows the passage of an electrical current for the partial recharging of the battery B1 by the main source GE. During the main discharging phases, the main discharging circuit can be optimized by closing K′1 to avoid Joule losses in the diode.

In this embodiment, the connection means K1, K′1, K2 and K′2 are power switches. These switches can be electromechanical such as a relay, or electronic such as an MOS transistor.

The switches, for example K1 and K′1 can be controlled independently of each other. Thus, for example, the discharge can interfere either by closing K1 or by closing K′1.

The diode functions D1 and D2 can be passive diodes or controlled switches, for example a transistor controlled by an electronic circuit performing the same function as a passive diode.

When the converter C3 is controlled to transfer a possible power from the battery B2 to the battery B1 (the electrical partial recharging circuit of B1 is open) and when the switch K1 (respectively K2) is closed, the diode D1 (respectively D2) allows the instantaneous main discharging of the battery B1 (respectively B2) and therefore obtaining uninterrupted power supply when the main power supply source GE is no longer providing current. If the batteries do not have the same common ground, the converter C3 must have an isolation function.

The closing of the switch K′1 (respectively K′2) allows the partial recharging of the battery B1 (respectively B2), but also during the main discharging phases the elimination by bypassing of the Joule losses and the voltage drop in the diode function D1 (respectively D2) due to the threshold voltage of the diode function D1 (respectively D2).

The opening of the pair K1 and K1′ (respectively K2 and K2′) allows stopping any discharge below a critical voltage threshold for electrochemistry, below which there is a risk of irreversibility of the reactions in the elements, particularly by dendrite metallization and internal short circuit with heading and initiation of an oxidation reaction or uncontrollable combustion.

The opening of the pair K1 and K′1 (respectively K2 and K′2) and the controlling of the converter C3 to not transfer power in both directions which allows resting the battery B1 (respectively B2).

The coupling module DC is configured to control:
a partial recharging of a battery Bi by the main source GE until a determined state of charge less than a maximum state of charge of this battery;
a saturation recharging of the battery Bi until said maximum state of charge by the secondary source, which is in this embodiment the other battery of the set; and
a main discharging of the battery Bi for supplying the consuming device BTS.

The saturation recharging of a battery Bi comprises a closing of the electrical saturation recharging circuit thereof and an opening of the electrical partial recharging and main discharging circuits thereof.

The coupling module DC controls the starting, the shutdown and the direction of the power transfer of the converter C3.

In the embodiment presented in FIG. 5, the connection means K1, K′1, K2, K′2, D1 and D2 are comprised in the control device DP. In another embodiment, these means are comprised in another device or another housing than the control device DP, but are controlled by the coupling module DC of the control device DP.

The control module CONT is configured to control the activity state of the main power supply source GE.

The monitoring module GET-MES is configured to obtain an information mes1 (resp. mes2) representing a state of charge of a battery B1 (resp. B2), for determining, depending on this information mes1 (or mes2) which battery among B1 and B2 is to be recharged or discharged.

In one embodiment, the main source is an electrical network N_ELEC.

FIG. 6 shows a functional architecture of the device DP included in the control system SYS according to another embodiment. In this embodiment, as in the embodiment previously described, a battery in a secondary discharging is used for a saturation recharging of another battery.

In the embodiment illustrated by FIG. 6, the saturation recharging circuit of the battery B1 includes a unidirectional converter C3b, with a voltage-boosting function optionally with an isolation. The saturation recharging circuit of the battery B2 includes a unidirectional converter C3a, with a voltage-boosting function optionally with a head-to-tail isolation of the converter C3b, thus forming the function performed by a bidirectional converter optionally with an isolation, such as the converter C3 described with reference to FIG. 5. The coupling module DC controls the starting and the shutdown of the converters C3a and C3b.

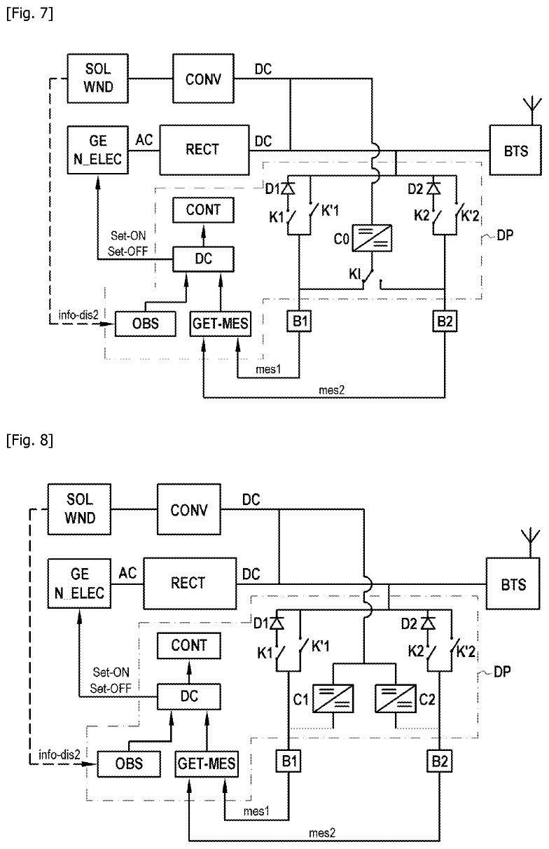

FIGS. 7 and 8 each show a functional architecture of a device DP included in a control system SYS according to embodiments in which the control system includes in addition to the main source GE, a secondary power supply source SOL or WND which is different from a battery of the set (neither B1 nor B2). The device DP controls the saturation recharging of the batteries by the secondary source SOL or WND.

In the embodiments described here, the secondary source SOL or WND produces electrical energy from a renewable energy, it may include one or more solar energy panel(s) (SOL) or wind turbines (WND). The source SOL is for example a photovoltaic converter which produces a variable DC voltage. The source WND is for example an electromechanical wind converter which produces an AC voltage whose voltage value and frequency depend on its speed of rotation. A converter CONV or a regulator can be placed at the output of the secondary source SOL (or WND) to adapt a DC (or AC) current generated by the secondary source SOL (or WND) into a regulated DC type current. The converter CONV and the rectifier RECT can be put in parallel but it is not necessary to obtain the saturation charge and to self-consume the excess energy, the latter can circulate through C0, C1, C2 according to the considered configuration.

The control device DP controls for each battery Bi, a saturation recharging by the secondary source SOL from a state of charge NRMIN to a maximum state of charge NRMAX after a determined number nCmax of cycles each comprising at least one partial recharging by the main source GE, not exceeding the level NRMIN.

In these embodiments, each of the batteries B1 and B2, is connected to the secondary source SOL by a controllable electrical saturation circuit.

To control a saturation recharging of a battery Bi, the coupling module DC of the control device DP is configured to control a closing of the electrical saturation circuit and an opening of the electrical partial recharging, main and secondary discharging circuits of this battery Bi.

In the embodiment illustrated by FIG. 7, the saturation circuit includes a voltage converter C0, in series with the batteries B1 and B2, and a switcher KI. The coupling module DC controls switching the switcher KI to the battery to be recharged by the secondary source SOL or to be opened relative to all the batteries, the starting and the shutdown of the converter C0.

In the embodiment illustrated by FIG. 8, the saturation circuit includes two voltage converters C1 and C2, each associated with one of the batteries B1 and B2.

In one embodiment, the secondary source is a wind turbine WND.

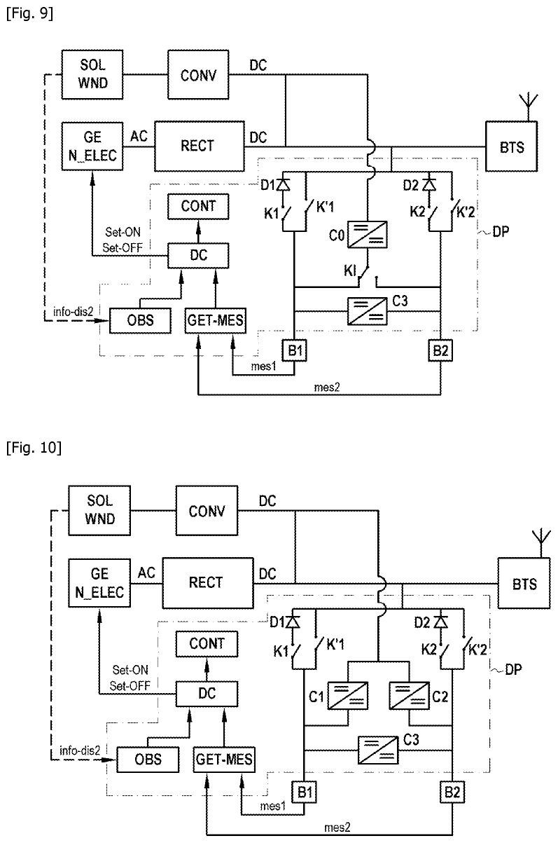

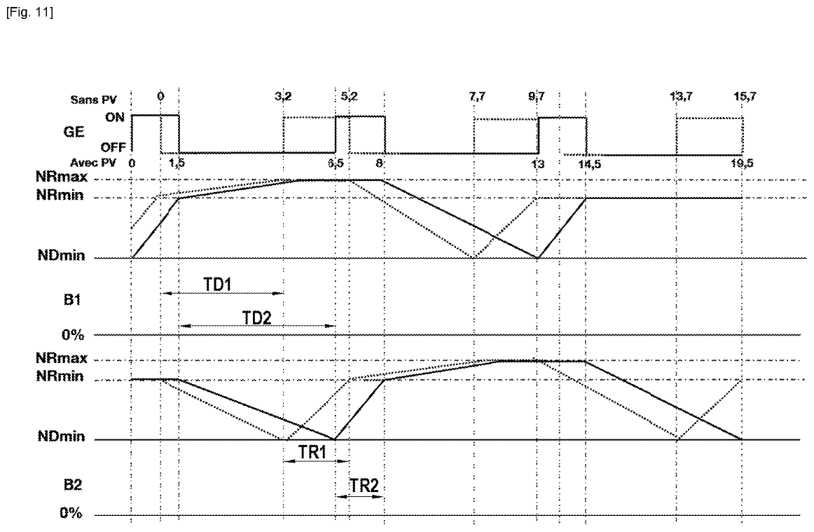

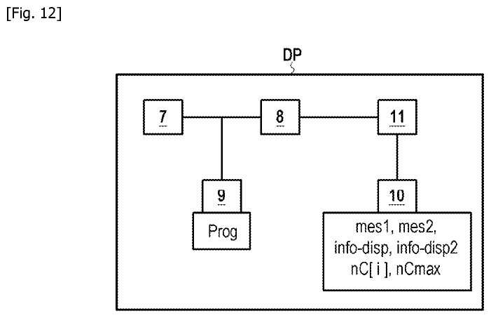

FIGS. 9 and 10 each show a functional architecture of a device DP included in a control system SYS according to embodiments in which the control system SYS includes in addition to the main source GE, a secondary source SOL different from a battery of the set. In these embodiments, the device DP can control a saturation recharging of a battery by the secondary source SOL and/or by the other battery of the set.

The architecture of FIG. 9 is a hybrid architecture of that of FIG. 5 and that of FIG. 7. The architecture of FIG. 10 is a hybrid architecture of that of FIG. 6 and that of FIG. 8.

In one embodiment, the control device DP includes a verification module OBS configured to verify an availability of the secondary source SOL.

In one embodiment, when the counter nC[i] associated with a battery Bi reaches the number nCmax, the control device DP obtains, by its verification module OBS, information info-disp2 on the availability of the secondary source SOL. If the secondary source SOL is available, the control device DP controls the saturation recharging of the battery Bi by the secondary source SOL. Otherwise, it controls the saturation recharging of the battery Bi by the other battery of the set.

FIG. 11 is a timetable showing the different steps of the control method in conformity with two embodiments. This timetable shows the evolution of the states of charge of the batteries B1 and B2 as a function of time, in hours.

The first embodiment corresponds to the embodiment described with reference to FIG. 4; the control method conforming to this first embodiment, can be implemented by a control device DP the architecture of which is that of FIG. 5 or FIG. 6. The states of charge corresponding to this embodiment are presented in dashed lines in FIG. 11. The control device DP controls a saturation recharging of the battery B1 by the battery B2 which is in secondary discharge, from the instant 0 to the hour 3.2. The duration of the secondary discharge of the battery B2 according to this first embodiment is denoted TD1. Then, the control device DP controls a partial recharging of the battery B2 by the main source GE, from the hour 3.2 to the hour 5.2. The duration of the partial recharging of the battery B2 according to this first embodiment is denoted TR1.

In the second embodiment, the control system includes in addition a secondary power supply source, SOL of the solar panel type. The states of charge corresponding to this embodiment are shown in solid lines. In this embodiment, as long as the secondary source SOL is available, it is used:
in addition to the main source GE for the partial recharging of the batteries from the level NDMIN to the level NRMIN;
for the saturation recharging of a battery (B1 for example) in addition to the other battery (B2) of the set, the other battery (B2) being in secondary discharge; and
for the power supply of the consuming device BTS in addition to the main source GE or to a battery in main discharge.

The control method conforming to this second embodiment, can be implemented by a control device DP the architecture of which is that of FIG. 9 or FIG. 10.

The duration of the discharging of the battery B2 according to the second embodiment is denoted TD2, it lasts from the hour 1.5 until the hour 6.5. During this discharge, firstly (from the hour 1.5 to the hour 3.2), the battery B2 recharges, with the secondary source SOL, the battery B1 and supplies the consuming device BTS (main and secondary discharge), then secondly (from the hour 3.2 to the hour 6.5), the battery B2 continues to supply the device BTS until its state of charge is equal to NDMIN (main discharging only).

In the second embodiment, the durations of the cycles are less controlled because the availability of the secondary source SOL (its energy production) cannot be controlled. The times shown in FIG. 11 are given as an indication.

In one embodiment, the availability of the intermittent secondary source SOL is predicted using an algorithm. This embodiment allows adapting the periodicity of the saturation recharges, for example by moving it forward by one or more cycle(s), in order to maximize the efficiency of the secondary source and the use of renewable energy.

At a same power of the main source GE, the partial recharging time TR2 of the second embodiment, in the presence of the secondary source SOL, is shorter than that of the first embodiment, TR1. In this example, TR2 is equal to one hour and a half, while TR1 is equal to 2 hours.

To implement the second embodiment, when dimensioning the system, it is necessary to ensure that the batteries accept the surplus power with a higher charging rate, because they will be recharged by two sources whose control of the secondary source SOL is not completely mastered in time. The control device DP can limit the power of the generator set GE by promoting the secondary source SOL without degrading the optimal efficiency of the generator set GE.

In this example, the discharging time of the battery B2 according to the first embodiment, TD1 is of 4 hours. In the second embodiment, the discharging time TD2 is of 5 hours. In fact, the contribution of the secondary source SOL reduces the contribution of the batteries, the discharging time is then longer for the same battery B2 (same depth of discharge DoD).

Material Architecture of the Control Device DP

In the embodiments described here, the control device DP has the architecture of a computer, as illustrated in FIG. 14. It comprises in particular a processor 7, a random access memory 8, a read-only memory 9, a non-volatile flash memory 10 in a particular embodiment, as well as communication means 11. Such means are known per se and are not described in more detail here.

The read-only memory 9 of the control device DP constitutes a recording medium, readable by the processor 7 and on which is recorded a computer program Prog.

The memory 10 of the control device DP allows recording the variables used for the execution of the steps of a method according to an embodiment described herein, such as the data mes1, mes2, mes3 representing the states of charge of the batteries, the information info-disp representing the activity states of the power supply sources, a value of the countdown timer TIMER used to estimate a state of charge of a battery.

The computer program Prog defines the functional and software modules configured for controlling batteries. These functional modules rely on and/or control the material elements 7-11 of the control device DP previously mentioned.

Upon obtaining information representing a state of charge:

The state of charge SoC of a battery can be expressed as a percentage relative to the available charge Q in the battery and the maximum capacity Cmax of this battery.

The charge Q and the state of charge SoC can be determined based on the voltage of the battery, if it reflects the state of recharge.

The voltage is high at the conclusion of recharging, for example greater than 3.45 V×k for lithium iron phosphate (LFP) batteries, k being the number of series elements constituting the battery.

The voltage is low at the conclusion of discharging, for example lower than 3 V×k for these types of batteries.

For certain battery technologies, the voltage is not a sufficiently accurate indicator for intermediate states of recharge and this measurement can be completed by a counter cumulating the charge Q at a given instant, this charge Q being assumed to be contained in the battery and bounded between 0 and the maximum capacity value Cmax.

The calculation of the charge Q uses at least measurements of current and of time, or even other measurements such as temperature and other information saved in memory such as reference data of the builder or historical data acquired during the use of the battery.

In one embodiment, the charge Q at an instant t+dt is expressed by:

Q(t+dt)=Q(t)+r.I.dt; where
I is the intensity of the recharging current (positive by convention) or discharging current (negative by convention) in the battery measured by means known to the prior art in the electronic field, such as the voltage on a shunt or a Hall effect sensor, and used by the control unit;
dt is an interval of measuring time with a current assumed to be constant or well smoothed on this interval by simple averaging or by calculation of the effective value, using for example a calculation method of the RMS (Root Mean Square) type;
r is the estimated efficiency; this efficiency r can have a constant value, for example 95%, or be variable; this efficiency r can depend on numerous parameters, such as:
a state of the battery during discharging or recharging, depending on the direction of current in the battery;
a state of recharge, for example the charging efficiency can collapse at the conclusion of recharging;
a temperature of the battery, for example lower efficiency when cold;
a recharging or discharging rate, for example a ratio between the current and the nominal capacity Cnom such as I=Cnom/3 and the efficiency is lower at a stronger rate;
a state of health of the battery described by the residual performance in capacity and power or internal resistance.

The state of health is affected by the age of the battery, also called calendar ageing, the cycling history, the temperature, the time spent at different depths of discharge, the recharging current, possible abuses undergone (overcharging, undercharging, short-circuit), poor maintenance, etc.

The state of recharge can be expressed by:

Q=Cmax·max (min (0%, Q(t+dt)), 100%)
where Cmax is for example 90% of the nominal capacity Cnom defined at an exchange current rate and a given temperature between the end of recharging and the end of discharging defined by the manufacturer, for example 100 Ah at 25° C. after a recharge of a battery to 30 amperes until 3.55V×k plus one hour at this constant voltage and down to 2.85V>k in discharging at 30 A.

In one embodiment, for better accuracy in calculation, the maximum value is corrected, for example depending on the nominal capacity of the battery, or depending on the state of health, or on the temperature.

In one embodiment, the measurements of state of charge of a battery can be acquired previously by a BMS entity associated with this battery.

In one embodiment, the information mes1 or mes2 are recovered via a communication link, for example a link of the analog, Modbus, CAN, FIP, Ethernet type or another type.

In one embodiment, at least one battery B1 is of the lithium type. The two parallel circuits, recharging and discharging, comprising means K1, K′1 and D1 relating to this battery B1, are comprised in the electronic management entity BMS associated with the battery B1.

In the foregoing description, specific details are given to provide a thorough understanding of the examples. However, it will be understood by one of ordinary skill in the art that the examples may be practiced without these specific details. Certain embodiments that are described separately herein can be combined in a single embodiment, and the features described with reference to a given embodiment also can be implemented in multiple embodiments separately or in any suitable subcombination. In some examples, certain structures and techniques may be shown in greater detail than other structures or techniques to further explain the examples.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method for controlling recharging and discharging of batteries of a set of batteries, each of the batteries being connected to an electrical circuit connecting a main power supply source to a consuming device to form a controllable electrical partial recharging circuit connecting the battery to the main power supply source and a controllable electrical main discharging circuit connecting the battery to the consuming device and performing a diode function to prevent a circulation current between the batteries, the main power supply source being able to produce electrical energy intermittently, at least one first battery of the set of batteries being connected to a secondary power supply source by a controllable electrical saturation recharging circuit, the method comprising:
a partial recharging of the first battery by the main power supply source until a determined state of charge less than a maximum state of charge of the first battery, the partial recharging comprising closing the electrical partial recharging circuit of the first battery; and
a saturation recharging of the first battery by the secondary source until the maximum state of charge, the saturation recharging comprising a closing of the electrical saturation recharging circuit and an opening of the electrical partial recharging and main discharging circuits of the first battery, the consuming device being supplied by the main source, and/or by the secondary source, and/or by a main discharging of one of the batteries, the main discharging of one of the batteries comprising an opening of the electrical partial recharging circuit and a closing of the electrical main discharging circuit of this battery.

2. The method of claim 1 further comprising a secondary discharging of the first battery for a saturation recharging of a second battery of the set, the first battery constituting the secondary source for the second battery, the secondary discharging comprising an opening of the partial recharging circuit of the first battery, the electrical saturation recharging circuit of the second battery forming an electrical secondary discharging circuit for the first battery.

3. The method of claim 1, comprising:
a first sequence including a saturation recharging, at least one partial recharging, and at least one main discharging, for said first battery; and
a second sequence including a saturation recharging, at least one partial recharging, and at least one main discharging, for one a third battery, the first and second sequences being temporally adjusted to ensure continuous power supply via the main discharging circuits of said first and third batteries.

4. The method of claim 1, further comprising, for at least one battery of the set of batteries, a cyclic sequence including:
at least one partial or saturation recharging followed by resting; or
at least one main or secondary discharging followed by resting, the resting including an opening of the electrical circuits of the battery.

5. The method of claim 1, further comprising obtaining an information representing a state of charge of one of the batteries for determining a battery that is in saturation recharging or partial recharging or main discharging.

6. The method of claim 5, further comprising determining a duration of activity and a duration of inactivity of the main source depending on the information representing the state of charge of one of the batteries.

7. A non-transitory computer readable medium having stored thereon instructions, which when executed by a processor, cause the processor to implement the method of claim 1.

8. A computer comprising a processor and a memory, the memory having stored thereon instructions, which when executed by the processor, cause the computer to implement the method of claim 1.

9. A device for controlling recharging and discharging of batteries of a set of the batteries, each of the batteries being connected to an electrical circuit connecting a main power supply source to a consuming device to form a controllable electrical partial recharging circuit connecting the battery to the main power supply source and a controllable electrical main discharging circuit connecting the battery to the consuming device and performing a diode function to prevent a circulation current between the batteries, the main power supply source being able to produce electrical energy intermittently, at least one first battery of the set of batteries being connected to a secondary power supply source by a controllable electrical saturation recharging circuit, the device configured to control:
a partial recharging of the first battery by the main source until a determined state of charge less than a maximum state of charge of the first battery, the partial recharging comprising a closing of the electrical partial recharging circuit of the first battery;
a saturation recharging of the first battery by the secondary source until the maximum state of charge, the saturation recharging comprising a closing of the electrical saturation recharging circuit and an opening of the electrical partial recharging and main discharging circuits of the first battery; and
a main discharging of a battery comprising an opening of the electrical partial recharging circuit and a closing of the electrical main discharging circuit of this battery, the device being configured to supply the consuming device by the main source and/or by the secondary source, and/or by a main discharging of one of the batteries.

10. The control device of claim 9, wherein the control device is further configured to obtain an information representing a state of charge of one of the batteries, to determine the battery to be recharged or discharged.

11. The control device of claim 9, wherein the control device is further configured to control an activity state of the main source.

12. The control device of claim 9, wherein the control device is further configured to control a resting of one of the batteries, wherein the resting comprises an opening of the electrical circuits of the battery.

13. A system for controlling recharging and discharging of batteries of a set of the batteries, each of the batteries being connected to an electrical circuit connecting a main power supply source to a consuming device to form a controllable electrical partial recharging circuit connecting the battery to the main power supply source and a controllable electrical main discharging circuit connecting the battery to the consuming device and performing a diode function to prevent a circulation current between the batteries, the main power supply source being able to produce electrical energy intermittently, at least one first battery of the set of batteries being connected to a secondary power supply source by a controllable electrical saturation recharging circuit, the system including:
the control device of claim 9;
the main source;
the secondary source; and
the consuming device.

14. The control system of claim 13, wherein the main source is a generator set or an electrical network.

15. The control system of claim 13, wherein the secondary source is:
a source that can produce electricity from renewable energy; or
one of the batteries in secondary discharge.
